(19) United States
(12) Patent Application Publication
(10) Pub. No.: US 2022/0252415 A1
(43) Pub. Date: Aug. 11, 2022

(54) Systems And Methods For Assigning Travel Routes Based On Vehicle Travel Range And Overhead Costs

(71) Applicant: Ford Global Technologies, LLC, Dearborn, MI (US)

(72) Inventors: Dominique Meroux, Fair Oaks, CA (US); Zhen Jiang, Mountain View, CA (US); Cassandra Telenko, San Francisco, CA (US)

(73) Assignee: Ford Global Technologies, LLC, Dearborn, MI (US)

(21) Appl. No.: 17/171,073

(22) Filed: Feb. 9, 2021

(51) Int. Cl. G01C 21/34; G08G 1/00; G01W 1/10; B60W 20/13; B60W 20/12

(52) U.S. Cl. CPC G01C 21/3469; G01C 21/3492; B60W 20/12; G01W 1/10; B60W 20/13; G08G 1/20

(57) ABSTRACT

The disclosure generally pertains to systems and methods for assigning travel routes to vehicles. An example method may involve evaluating a first vehicle for deploying on a first travel route and a second vehicle for a second travel route. Evaluating the first vehicle may include determining a first probability that the first vehicle will need a first energy replenishment operation during deployment on the first travel route, and also determining a first deployment cost for the first vehicle. The first deployment cost can include a first energy replenishment cost based on the first probability. Evaluating the second vehicle may include determining a second deployment cost for the second vehicle, the second deployment cost including a second energy replenishment cost. The first vehicle is assigned to the first travel route and the second vehicle to the second travel route if the first deployment cost is less than the second deployment cost.

### BACKGROUND

The push towards ecofriendly mobility solutions that are trying to replace gasoline vehicles with other types of vehicles is gradually gaining ground as various hurdles are being overcome. One significant hurdle that is associated with the deployment of electric vehicles is the limited travel range offered by existing batteries. Ongoing efforts at improving in battery technology, coupled with infrastructure development that enables charging of vehicle batteries ubiquitously, are addressing this issue and making electric vehicles more attractive to individuals as well as to vehicle fleet operators.

Individuals typically analyze several factors before purchasing an electric vehicle and follow certain cost-saving procedures afterwards when operating the electric vehicle. For example, an individual, may, prior to purchase, compare operating costs of an electric vehicle against those of a gasoline vehicle and may also analyze his/her commute distances in order to ensure that a travel range provided by the electric vehicle does not leave him/her stranded without access to a charging station.

Fleet operators may be somewhat more hesitant to purchase electric vehicles particularly when it is difficult to identify a travel range that can be uniformly applied to all vehicles of a fleet. More particularly, a transport company may find it difficult to determine how many electric vehicles to include in a fleet that already includes several gasoline vehicles. Even when electric vehicles are included in the fleet, it may be cumbersome and time consuming to execute certain fleet operations such as, for example, determining which types of vehicles (electric or gasoline) to deploy over various destinations and distances. One solution to this issue may involve setting a conservative range of travel for all the electric vehicles in the fleet. The conservative range of travel may be based on factors such as, for example, a travel range of some of the vehicles that do not have a large battery capacity. Such vehicles may be unable to travel over the same distances on a full battery charge as other vehicles of the fleet that have higher battery capacities. The shortcoming in such a solution lies in the fact that the vehicles having higher battery capacities may be underutilized and bear unnecessary cost penalties such as, for example, a higher purchase price in comparison to the low travel range vehicles.

It is therefore desirable to provide solutions that address issues such as the ones described above.

### DESCRIPTION OF THE FIGURES

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 shows an example vehicle assignment system that may be used to assign travel routes to various types of vehicles in accordance with an embodiment of the disclosure.

FIG. 2 shows a table indicating battery characteristics of some example electric vehicles in accordance with an embodiment of the disclosure.

FIG. 3 shows a table indicating some example travel routes and vehicle assignments to these travel routes based on vehicle characteristics.

FIG. 4 illustrates a flowchart of an example procedure to assign an electric vehicle to a travel route in accordance with an embodiment of the disclosure.

FIG. 5 illustrates a flowchart of an example procedure to provide battery charging to an electric vehicle traveling on a travel route in accordance with an embodiment of the disclosure.

FIG. 6 illustrates another flowchart of an example procedure to assign an electric vehicle to a travel route in accordance with an embodiment of the disclosure.

### DETAILED DESCRIPTION

Overview

The disclosure generally pertains to systems and methods for assigning travel routes to vehicles. An example method may involve evaluating a first vehicle for deploying on a first travel route and a second vehicle for a second travel route. Evaluating the first vehicle may include determining a first probability that the first vehicle will need a first energy replenishment operation during deployment on the first travel route, and also determining a first deployment cost for the first vehicle. The first deployment cost can include a first energy replenishment cost based on the first probability. Evaluating the second vehicle may include determining a second deployment cost for the second vehicle, the second deployment cost including a second energy replenishment cost. The first vehicle is assigned to the first travel route and the second vehicle to the second travel route if the first deployment cost is less than the second deployment cost. The second vehicle may be a gasoline-operated vehicle or a hybrid vehicle in some cases, and evaluating this vehicle can include determining a deployment cost that includes a cost of gasoline. In an example scenario, the second travel route may be shorter than the first travel route. Assigning the gasoline vehicle or the hybrid vehicle to the shorter of the two travel routes may constitute an optimal assignment strategy in comparison to assigning the gasoline vehicle or the hybrid vehicle to the longer travel route based, for example, on vehicle range alone.

### Illustrative Embodiments

The disclosure will be described more fully hereinafter with reference to the accompanying drawings, in which example embodiments of the disclosure are shown. This disclosure may, however, be embodied in many different forms and should not be construed as limited to the example embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described example embodiments but should be defined only in accordance with the following claims and their equivalents. The description below has been presented for the purposes of illustration and is not intended to be exhaustive or to be limited to the precise form disclosed. It should be understood that alternate implementations may be used in any combination desired to form additional hybrid implementations of the present disclosure. For example, any of the functionalities described with respect to a particular device or component may be performed by another device or component. Furthermore, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

Certain words and phrases are used herein solely for convenience and such words and terms should be interpreted as referring to various objects and actions that are generally understood in various forms and equivalencies by persons of ordinary skill in the art. For example, the word “vehicle” as used in this disclosure can pertain to any of various types of vehicles, such as, for example, a truck, a semi-trailer, a flatbed, a car, a van, a sports utility vehicle, and a bus. A fleet of vehicles as used for purposes of description below can include one or more gasoline vehicles and one or more alternative fuel vehicles. A few examples of alternative fuel vehicles can include electric vehicles, hybrid electric-gasoline vehicles, plug-in hybrid electric-gasoline vehicles, fuel cell vehicles, and compressed natural gas (CNG) vehicles. It must be understood that subject matter disclosed herein with respect to an “electric vehicle” or a “gasoline vehicle” can be equally applicable to various other types of vehicles. For example, description related to a battery capacity of an electric vehicle should be understood as being equally applicable to a storage capacity of a tank in a CNG vehicle. Similarly, description related to a travel range of an electric vehicle based on an amount of charge stored in a rechargeable battery of the electric vehicle should be understood as being equally applicable to a travel range of a CNG vehicle based on an amount of CNG gas stored in a tank of the CNG vehicle or to a travel range of a gasoline vehicle based on an amount of gasoline stored in a tank of the gasoline vehicle. Any comparisons described in this disclosure with reference to an electric vehicle and a gasoline vehicle (or hybrid vehicle) may be equally applicable to two or more vehicles having different types of powertrains such as, for example, between a plug-in electric hybrid vehicle (PHEV) and a hydrogen vehicle, and/or between an earlier-model electric vehicle with an older type of battery and a newer-model electric vehicle with a newer type of battery. The word “battery” as used herein is not necessarily limited to a single battery and generally pertains to a battery system having a bank of batteries that provides electrical power to one or motors coupled to the wheels of an electric vehicle.

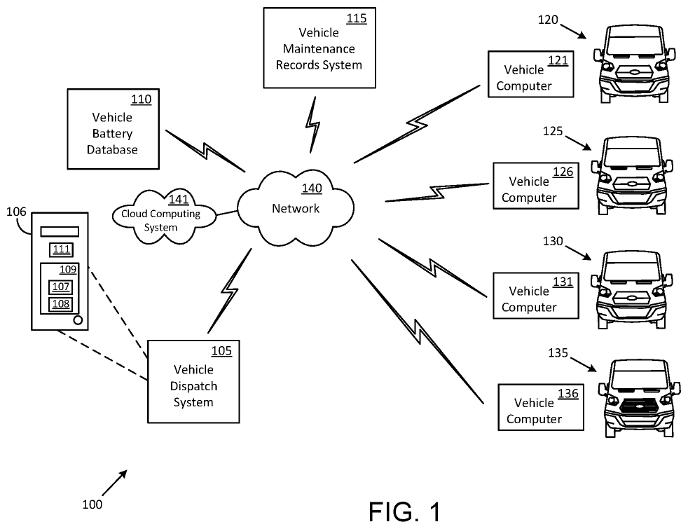

FIG. 1 shows an example vehicle assignment system 100 that may be used to assign travel routes to various types of vehicles in accordance with an embodiment of the disclosure. The example vehicle assignment system 100 may include a vehicle dispatch system 105, a vehicle battery database 110, a vehicle maintenance records system 115, and a fleet of vehicles. In this example scenario, the fleet of vehicles includes a first electric vehicle 120, a second electric vehicle 125, a third electric vehicle 130, and a gasoline vehicle 135. In other scenarios the fleet of vehicles may include more than one gasoline vehicle and fewer or more than three other vehicles that may be electric vehicles or other types of alternative fuel vehicles.

The vehicle dispatch system 105 may include one or more computers that are communicatively coupled to a network 140, such as, for example, a computer 106 that is communicatively coupled to the network 140. The computer 106 may be any of various types of computers such as, for example, a desktop computer, a laptop computer, a tablet computer, or a handheld device such as a smartphone containing a processor and a memory. The computer 106 generally includes a processor 111 and a memory 109. The memory 109, which is one example of a non-transitory computer-readable medium, may be used to store an operating system (OS) 108 and various other code modules such as, for example, a software application 107 that may be downloaded into the memory 109. The software application 107 can be executed by the processor 111 for performing various operations in accordance with disclosure such as, for example, assigning various vehicles of the fleet to various travel routes. Some operational aspects of the software application are described below in the form of various methods and procedures to assign various vehicles to various travel routes.

The vehicle battery database 110 and the vehicle maintenance records system 115 may also include one or more computers (not shown) that are communicatively coupled to the network 140. The first electric vehicle 120 may include a vehicle computer 121 that is communicatively coupled to the network 140. The second electric vehicle 125 may include a vehicle computer 126 that is communicatively coupled to the network 140. The third electric vehicle 130 may include a vehicle computer 131 that is communicatively coupled to the network 140. The gasoline vehicle 135 may include a vehicle computer 136 that is communicatively coupled to the network 140.

The network 140 may include any one network, or a combination of networks, such as, for example, a local area network (LAN), a wide area network (WAN), a telephone network, a cellular network, a cable network, a wireless network, and/or private/public networks such as the Internet. A cloud computing system 141 that is coupled to the network 140 offers cloud-based services using one or more computers and one or more storage elements. The various components that are communicatively coupled to the network 140 may communicate with each other by using various communication technologies such as, for example, TCP/IP, Bluetooth, cellular, near-field communication (NFC), Wi-Fi, Wi-Fi direct, vehicle-to-vehicle (V2V) communication, vehicle-to-everything (V2X), and/or vehicle-to-infrastructure (V2I) communication.

A travel route assignment procedure in accordance with the disclosure may be executed by launching the software application 107 in the computer 106. In an example procedure, the software application 107 may obtain information from various sources via the network 140. For example, information pertaining to a battery provided in an electric vehicle in the fleet may be obtained from the vehicle battery database 110. Some examples of such information regarding a battery may include a data of manufacture of the battery, a kWh rating of the battery, a use-before date of the battery, a performance history of the battery, customer reviews of the battery, and/or product compatibility for use in an electric vehicle.

The software application 107 may obtain vehicle maintenance records system 115 of a vehicle, such as, for example, maintenance records of the gasoline vehicle 135. Some examples of such records may include oil changes, tire replacement, parts replacements, mileage, and/or condition of various parts of the vehicle (coolant system, transmission, alternator, etc.). In some implementations, various conditions of the gasoline vehicle 135 may be dynamically modified in the vehicle maintenance records system 115 at various times such as, for example, prior to deployment on a travel route, when traveling on a travel route, upon reaching a destination, etc. The dynamically updated conditions can include, for example, tire pressure, oil level, coolant level, and battery parameters. In the case of electric vehicles, the vehicle maintenance records system 115 may provide information such as, for example, software updates carried out upon the vehicle computer 121 of the first electric vehicle 120, software and/or hardware issues in the vehicle computer 121 of the first electric vehicle 120, and/or a performance history of the vehicle computer 121 of the first electric vehicle 120 (crashes, malfunctions, security issues, etc.).

In an operation in accordance with the disclosure, the software application 107 may use the information obtained from the various sources (such as the vehicle battery database 110 and the vehicle maintenance records system 115) to assign travel routes to some or all of the vehicles of the fleet. Travel route assignments may be carried out by evaluating a battery health of a rechargeable battery installed in one or more of the electric vehicles. The battery health may be used to determine various operating conditions of an electric vehicle, such as, for example, a travel range of the electric vehicle after a battery of the electric vehicle is fully charged. The travel range may be impacted by various aspects of the battery such as, for example, a reduction in battery performance due to various factors such as age, operating environment, and stress. Evaluation of the battery health may be carried out at various times.

In an example operation where, for example, the first electric vehicle 120 has been assigned a travel route, the software application 107 may evaluate a health of the battery in the first electric vehicle 120 before the first electric vehicle 120 starts out on the assigned travel route. The evaluation may be directed at determining when and where a recharging operation of the battery may be required along the travel route, if at all. In another scenario, the evaluation may be performed by the software application 107 while the first electric vehicle 120 is moving on the travel route, and variable like the usage of the vehicles HVAC, driving speed, ambient temperature, use of lights and windshield wipers, etc. are impacting the energy consumed by the vehicle. Arrangements may be made to direct the first electric vehicle 120 to a battery recharging station or to rendezvous with a recharging vehicle (or a replacement vehicle). In an example scenario, the recharging vehicle may transfer power from a battery of the recharging vehicle to a battery of the first electric vehicle 120. The battery of the recharging vehicle may have a higher amount of charge than the battery of the first electric vehicle 120 to execute the recharging operation.

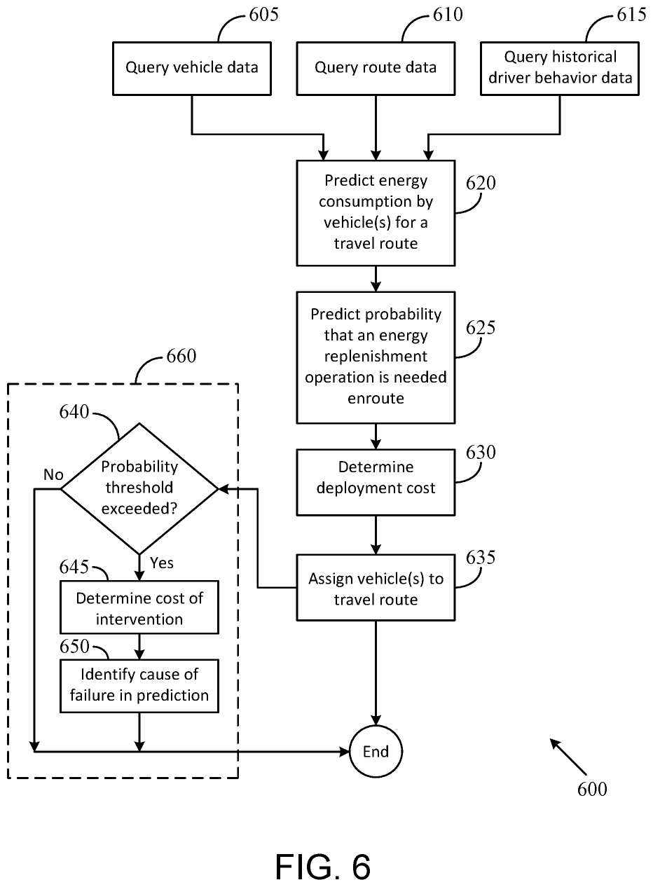

In the case of the recharging vehicle, arrangements may involve dispatching the recharging vehicle to a rendezvous location before the first electric vehicle 120 reaches the rendezvous location. The recharging vehicle may be equipped to transport other types of fuels (such as, LPG gas, for example) when the vehicle is other than an electric vehicle. In an alternative arrangement, the first electric vehicle 120 may be directed to travel to a specific recharging station on the travel route. The directions may be provided either before, or after, the first electric vehicle 120 has reached a spot on the travel route where the battery is expected to require recharging. Planning and arranging for recharging operations ahead of time can minimize or eliminate certain types of overhead costs associated with unplanned stoppages and delays due to a rechargeable battery of the first electric vehicle 120 running out of charge (or an alternate fuel vehicle running out of fuel) when executing a travel route assignment. Additional types of costs associated with unplanned stoppages and delays are described below with respect to FIG. 6.

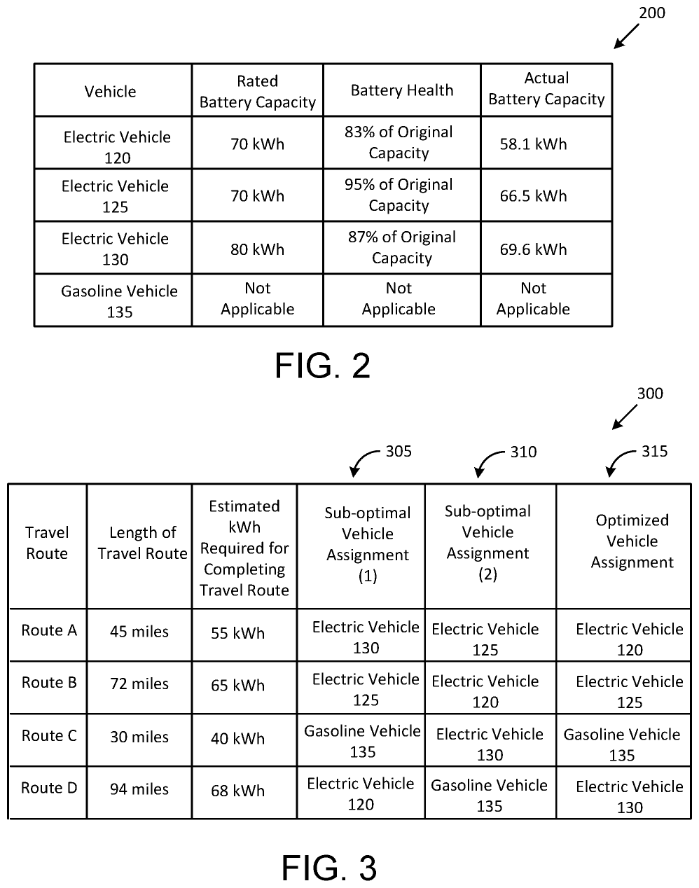

FIG. 2 shows a table 200 indicating battery characteristics of some example electric vehicles in accordance with an embodiment of the disclosure. The first electric vehicle 120 is operated on a rechargeable battery having a rated battery capacity of 70 kWh. However, the rechargeable battery has degraded due to various factors such as, for example, an extended period of use, poor maintenance, and/or stress (excessive current draw, temperature, humidity, etc.). The degradation may affect a current health of the rechargeable battery, which, in this example, is 83% of original capacity. Consequently, the actual battery capacity that can be provided by the rechargeable battery is 58.1 kWh (83% of 70 kWh). The health of the rechargeable battery in the first electric vehicle 120 as well as in other electric vehicles, generally reflects a reduction in a charge retaining capacity, a watt-hour rating, a charging rate, and/or a mean-time-between-failures (MTBF) rating in comparison to an original charge retaining capacity, an original watt-hour rating, an original charging rate, and/or an original mean-time-between-failures (MTBF) rating respectively.

The second electric vehicle 125 has a rechargeable battery having a rated battery capacity of 70 kWh. The current health of the rechargeable battery as a result of degradation is 95% of original capacity. Consequently, the actual battery capacity that can be provided by this rechargeable battery is 66.5 kWh (95% of 70 kWh).

The electric vehicle 130 has a rechargeable battery having a rated battery capacity of 80 kWh. The current health of the rechargeable battery as a result of degradation is 87% of original capacity. Consequently, the actual battery capacity that can be provided by this rechargeable battery is 69.6 kWh (87% of 80 kWh).

The gasoline vehicle 135 runs on a gasoline engine. A rechargeable battery that is provided in the gasoline vehicle 135 is typically used for starting the engine but not for moving the gasoline vehicle 135. The rechargeable battery of the gasoline vehicle 135 is charged by an alternator when the gasoline engine is in operation. A travel range of the gasoline vehicle 135 is generally dependent on the size of its fuel tank and the quality of fuel used. Performance degradation in terms of travel range may be present in the gasoline vehicle 135 due to factors such as engine performance and wear and tear on various components.

FIG. 3 shows a table 300 indicating some example travel routes and vehicle assignments to these travel routes based on vehicle characteristics. Route A is 45 miles long and an estimated battery rating of 55 kWh is required by an electric vehicle to complete this travel route. The estimated battery rating (kWh) may be based on charging a rechargeable battery to a certain charge level (100% capacity, for example) and estimating a travel range of an electric vehicle before the rechargeable battery drops to a charge level where a recharging operation is required. The health of a rechargeable battery may affect the amount of charge that is stored in the rechargeable battery upon charging the rechargeable battery to 100% of its capacity, and may also affect a discharge rate and charge storage characteristics when the rechargeable battery is used for moving an electric vehicle. This aspect is indicated in table 200 as the actual battery capacity of a rechargeable battery.

Route B shown in table 300 is 72 miles long and an estimated battery rating of 65 kWh is required by an electric vehicle to traverse Route B. Another Route C that is shown in table 300 is 30 miles long and an estimated battery rating of 40 kWh is required by an electric vehicle to traverse Route C. Route D, which is the longest travel route shown in table 300, is 94 miles long and an estimated battery rating of 68 kWh is required by an electric vehicle to traverse Route D.

Various types of vehicle assignment procedures may be employed for assigning the example vehicles shown in table 200 to the example travel routes shown in table 300. A first vehicle assignment procedure that is illustrated in column 305 may be executed on a first-come-first-served basis where a first driver is offered a choice of any of the example vehicles and any of the example travel routes. A second driver who comes in next is offered a choice of any of the remaining vehicles and any of the remaining travel routes, and so on.

This first vehicle assignment procedure can be sub-optimal for several reasons. The first driver may select the gasoline vehicle 135 and the shortest travel route (Route C). The second driver may select the third electric vehicle 130 and the next shortest travel route (Route A). A third driver may select the second electric vehicle 125 and the next shortest travel route (Route B). A fourth driver has no choice but to select the first electric vehicle 120 and the remaining travel route (Route D). Route D is 94 miles long and the estimated kWh required for completing the travel route without a recharging operation along the way, is 68 kWh. The rechargeable battery of the first electric vehicle 120 has an actual battery capacity of only 58.1 kWh. Consequently, a recharging operation is required enroute Route D, thereby adding an unnecessary overhead cost that may have been avoidable with a more strategic vehicle assignment procedure.

A second vehicle assignment procedure may be executed by assigning the gasoline vehicle 135 to the longest travel route (Route D) and assigning the electric vehicles to the remaining travel routes in the manner shown in column 310 of the table 300. The estimated kWh required for the travel routes other than Route D are 55 kWh (Route A), 65 kWh (Route B), and 40 kWh (Route C). As indicated in table 200, the rechargeable battery in the first electric vehicle 120 has a rated battery capacity of 70 kWh, the rechargeable battery in the second electric vehicle 125 has a rated battery capacity of 70 kWh, and the rechargeable battery in the third electric vehicle 130 has a rated battery capacity of 80 kWh, each of which exceeds the estimated 65 kWh that is needed for the next longest travel route (Route B).

However, table 200 also indicates that in contrast to the rated battery capacities, the actual battery capacities of the rechargeable batteries is lower due to deteriorated battery health. Consequently, the first electric vehicle 120 may be unable to complete Route B. A driver of the first electric vehicle 120 may set off on Route B after charging the rechargeable battery in the first electric vehicle 120. The rechargeable battery runs out of adequate charge enroute to complete Route B. When this occurs, the driver may place a call to a head office to report that a recharging operation is required at a charging station nearby and/or to place a request that a replacement vehicle be dispatched for transferring goods from the first electric vehicle 120 to the replacement vehicle in order to complete a shipment of the goods on time. The overhead costs associated with providing a recharging operation enroute (or dispatching a replacement vehicle) that is a part of this second vehicle assignment procedure may have been avoidable with employment of a more strategic vehicle assignment procedure.

The shortcomings in the two vehicle assignment procedures described above may be addressed by an optimized vehicle assignment procedure that is based on evaluating various factors prior to assigning various vehicles to various travel routes. The various vehicles that are assigned to the various travel routes in accordance with the optimized vehicle assignment procedure are shown in column 315 of the table 300. The assignments may be based on first determining whether any of the electric vehicles can complete the longest route (Route D) based on the actual battery capacities shown in table 200. The third electric vehicle 130 has an actual battery capacity of 69.6 kWh, which satisfies the estimated 68 kWh required for Route D. The other two electric vehicles are unsuitable for Route D. Consequently, the third electric vehicle 130 may be assigned to Route D. The next longest route (Route B) requires an estimated 65 kWh and the second electric vehicle 125 having an actual battery capacity of 66.5 kWh is suitable for this route. Hence, the second electric vehicle 125 may be assigned to Route B. The next longest route (Route A) requires an estimated 55 kWh and the first electric vehicle 120 having an actual battery capacity of 58.1 kWh is suitable for this route. Hence, the first electric vehicle 120 may be assigned to Route A. The gasoline vehicle 135 is assigned to the remaining route (Route C), which is the shortest of all the travel routes. The optimized vehicle assignment runs counter to a conventional “safe” approach where the gasoline vehicle 135 is assigned the longest route (Route D) followed by assignment of electric vehicles to the remaining routes. By prioritizing the consideration of the amount of estimated energy consumed along a route rather than distance results in vehicles assignments that minimize overall costs.

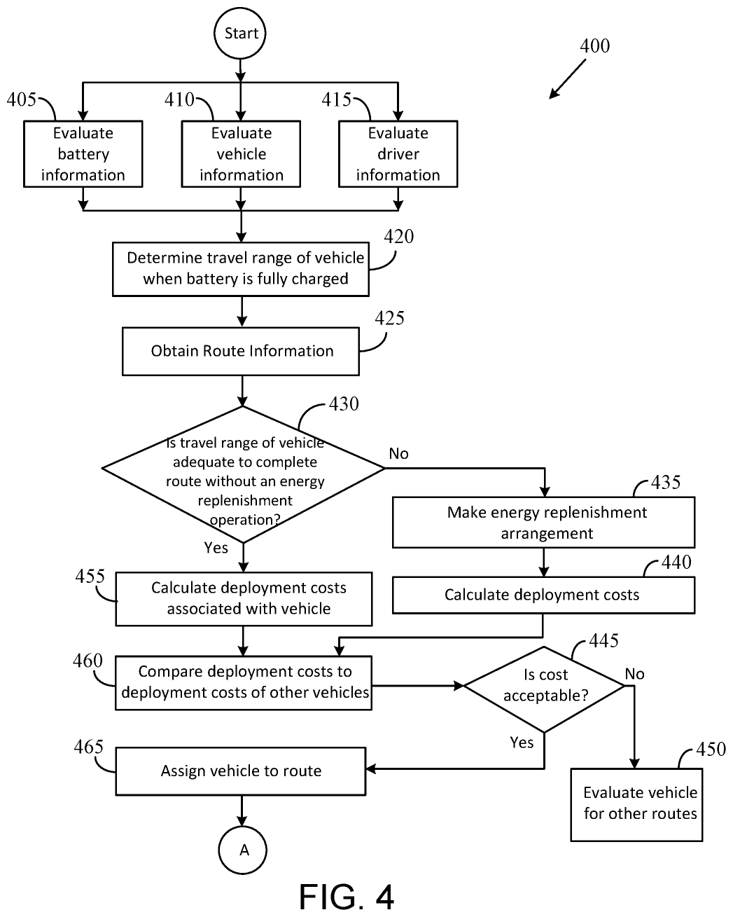

FIG. 4 illustrates a flowchart 400 of an example vehicle assignment procedure that includes such operations in accordance with an embodiment of the disclosure. The flowchart 400 illustrates a sequence of operations that can be implemented in hardware, software, or a combination thereof. In the context of software, the operations represent computer-executable instructions stored on one or more non-transitory computer-readable media, such as the memory 109 in the computer 106, that, when executed by one or more processors, such as the processor 111 in the computer 106, perform the recited operations. One example of a software containing such computer-executable instructions is the software application 107 provided in the computer 106. Generally, computer-executable instructions include routines, programs, objects, components, data structures, and the like that perform particular functions or implement particular abstract data types. The order in which the operations are described is not intended to be construed as a limitation, and any number of the described operations may be carried out in a different order, omitted, combined in any order, and/or carried out in parallel.

At block 405, battery information of an electric vehicle is evaluated. The evaluation may be performed by a vehicle dispatch system based on obtaining battery information via a network, from sources such as, for example, a vehicle battery database or a cloud computing system. Some examples of such battery information may include a date of manufacture of the battery, a kWh rating of the battery, a use-before date of the battery, a performance history of the battery, customer reviews of the battery, a MTBF rating of the battery, and/or product compatibility for use in the electric vehicle.

At block 410, which may happen in serial or parallel fashion relative to step 405, vehicle information of the electric vehicle is evaluated. The evaluation may be performed by the vehicle dispatch system obtaining vehicle information via a network, from sources such as, for example, a vehicle maintenance records system. Some examples of such vehicle information may include, for example, a status of software provided in a computer of the electric vehicle, software and/or hardware issues in the computer of the electric vehicle, and a performance history of the computer of the electric vehicle (crashes, malfunctions, security issues, etc.). Vehicle information may also include date of manufacture of the electric vehicle, date on which the electric vehicle was placed in service, an accident history of the electric vehicle, repairs carried out upon the electric vehicle, mileage of the electric vehicle

At block 415, which may happen in serial or parallel fashion relative to steps 405 and 410, information about a driver of an electric vehicle may be evaluated. In some cases, this action may be omitted such as, for example, when the electric vehicle is an autonomous vehicle that does not require a driver, or when privacy laws prevent such an evaluation being carried out (such as, for example, upon a customer who rents the electric vehicle for personal use). Some examples of information about a driver of an electric vehicle may include, for example, a driving history, an accident history, and a number of speeding tickets received. The speeding tickets may provide an indication that the driver has a lead foot that may lead to increased battery consumption and reduced mileage of the electric vehicle.

At block 420, the battery information and/or the vehicle information may be combined with the driver information (if obtained), and a travel range of the electric vehicle may be determined. In an example scenario, the travel range of the electric vehicle may be determined on the basis of the health of a battery. In this case, an amount of charge that is stored in the battery upon completion of a charging operation, may depend on various factors such as, for example, a deterioration in the health of the battery (charge holding capacity, charge leakage, corrosion effects, temperature effects, etc.).

In another example scenario, the travel range of the electric vehicle may be determined on the basis of a driving characteristic of the driver. A careful driver may be unavailable (sickness, holiday, etc.) on a particular day and a replacement driver who is available may be an aggressive driver who handles an electric vehicle in an uneconomical manner. In this scenario, the driving characteristics of the aggressive driver may be taken into consideration when determining the travel range of the electric vehicle.

At block 425, route information may be obtained about a travel route that is being considered for assigning to the electric vehicle. Travel route information may include, for example, a distance of the travel route, grade information of the travel route (flat, mountainous, steep gradients, etc.), speed limits on the travel route (maximum speed, minimum speed, law enforcement of speed rules, etc.), and/or telematics data. In some cases, telematics data about the travel route may be derived from historical information and/or various data sources (real-time traffic reports, weather reports, etc.). Some examples of such telematic data may include high-precision grade information of a particular road on the travel route, historical speed profiles of vehicles traveling on the travel route, and/or temperature data along sections of the travel route.

At block 430, a determination is made whether the travel range of the vehicle is adequate to complete the travel route without an energy replenishment operation such as, for example, a battery recharging operation or a CNG recharging operation.

If the determination at block 430 indicates that the travel range of the electric vehicle is adequate to complete the travel route, at block 455, deployment costs associated with deploying the electric vehicle on the travel route are calculated. In an example scenario, the deployment cost of the electric vehicle may be calculated as a part of calculating deployment costs of some or all vehicles of a fleet of vehicles. Some or all of the vehicles of the fleet may be deployed based on factors such as, for example, predicted feasibility for deployment of a type of vehicle, lowest expected operating cost, cost savings due to eliminating use of gasoline, maintenance costs, and/or net expected cost of fuel such as CNG.

Deployment costs may be broadly characterized under three categories—fuel costs, maintenance costs, and “other operations” costs. Fuel costs can encompass cost penalties associated with events such as a charging operation carried out upon an electric vehicle prior to the electric vehicle starting out on a travel route, cost of gasoline for fueling a gasoline vehicle, cost of CNG for fueling a CNG vehicle, cost of deviating from the travel route for refueling/recharging, and/or time delays due to recharging/refueling.

Maintenance costs may be calculated on a per-mile basis in one example scenario. The per-mile costs can vary significantly based on the type of vehicle that is evaluated. For example, a maintenance cost estimate carried out on a per-mile basis for a gasoline vehicle may take into consideration that no oil change or maintenance is required upon the gasoline vehicle when the gasoline vehicle has traveled less than a threshold mileage. However, such costs may be included when the gasoline vehicle has exceeded the threshold mileage for such operations. An electric vehicle does not require certain operation such as an engine oil change or engine overhaul but may require battery replacement after the health of the battery has deteriorated to an unacceptable level. Such a battery replacement, which can be expensive, is not applicable to the gasoline vehicle.

Operations costs other than fuel costs and maintenance costs may include various other types of costs such as, for example, a cost of insurance for operating a vehicle, rebates/benefits provided to alternative fuel vehicles, and traveling around no-emissions zones.

The three types of costs described above may be expressed in mathematical form as follows:

For vehicles i∈{1, . . . , N} and daily routes j∈{1, . . . , M}

E[cost(deployment)]=ΣΣMj=1E[fuel cost]ijNi=1+E[maintenance cost]ij+E[unplanned refuel event cost]ij+E[other operations cost,E.g.insurance]ij

Expected cost values in the mathematical expression above, are provided in a conventional format (E[X]=X) that intrinsically includes a probability component. The impact of the probability component may be described with an example wherein an expected value of a coin toss with a reward of 1 for heads and a cost of −1 for tails would be:

E[coin Toss Winnings]=½×1+½×(−1)=0.5−0.5=0

An objective for assigning an electric vehicle to a travel route may be generally defined as a strategy to minimize expected travel costs based on travel range and operating constraints. However, determining a travel cost such as a probability that the electric vehicle will require battery recharging when moving on an assigned travel route involves a certain level of uncertainty. Consequently, a calculation in this matter should reflect an uncertainty factor in the input variables. The uncertainty factor may be based on various historical parameters, certain types of metadata, and/or on simulations. For example, it may be preferable when making a battery recharging requirement calculation for a travel route that passes through a cold region of the country (or during winter) to include an uncertainty factor based on the use of a heater in the vehicle. The travel range of the vehicle may be affected by various aspects of the heater, such as, for example, historical data reflecting a power draw by the heater upon a battery of a vehicle as a result of opening and closing of doors during travel on the travel route, personal temperature preferences of a driver, and/or data accumulated from previous experiences of various drivers in various vehicles.

If, at block 430 it is determined that an energy replenishment operation is needed, at block 435, arrangements may be made to execute the energy replenishment operation. If the vehicle is an electric vehicle, the energy replenishment operation can involve a battery charging operation of the electric vehicle at a suitable location along the travel route. If the vehicle is an alternative fuel vessel such as, for example, a CNG vehicle, at block 435, arrangements may be made to deliver CNG containers to the CNG vehicle, and/or to replenish a CNG tank in the CNG vehicle. If the vehicle is a hybrid-electric vehicle, recharging/refueling arrangements will not be needed because a gasoline engine of the hybrid-electric vehicle will provide power needed to move the hybrid-electric vehicle until the rechargeable battery is recharged by the hybrid-electric vehicle in motion.

At block 440, a deployment cost may be determined. The deployment cost can include costs due to energy replenishment operations such as, for example, a battery recharging operation, replenishing CNG fuel in the CNG vehicle, or operating the gasoline engine in the hybrid electric vehicle. A battery charging operation can include, for example, costs associated with the use of a charging station at an electric battery charging facility, costs associated with a time delay due to the recharging operation, and/or costs associated with payment to a driver of an electric vehicle due to the additional driving time.

At block 460, the deployment costs associated with the electric vehicle may be compared to deployment costs of other vehicles (the CNG vehicle or the hybrid electric vehicle, for example). The comparison may take into consideration various aspects such as, for example, the deployment cost that is determined at block 440, weather conditions on the travel route, a target deployment cost, type of cargo to be transported, characteristics of one or more drivers, vehicle characteristics (gasoline vehicle, CNG vehicle, etc.), battery charging limitations, refueling limitations, range of travel before recharging/refueling, and/or driving limitations (speed limits, zones where only zero-emission vehicles are allowed, tolls for different types of vehicles, etc.

At block 445, a determination is made whether the deployment costs determined at block 460 for the evaluated vehicle, is acceptable. If found unacceptable, at block 450, a different vehicle may be evaluated for assigning to the travel route and/or the electric vehicle may be evaluated for a different travel route. If the deployment cost comparison of the electric vehicle is favorable in comparison to the other vehicles, at block 465, the electric vehicle is assigned to the travel route.

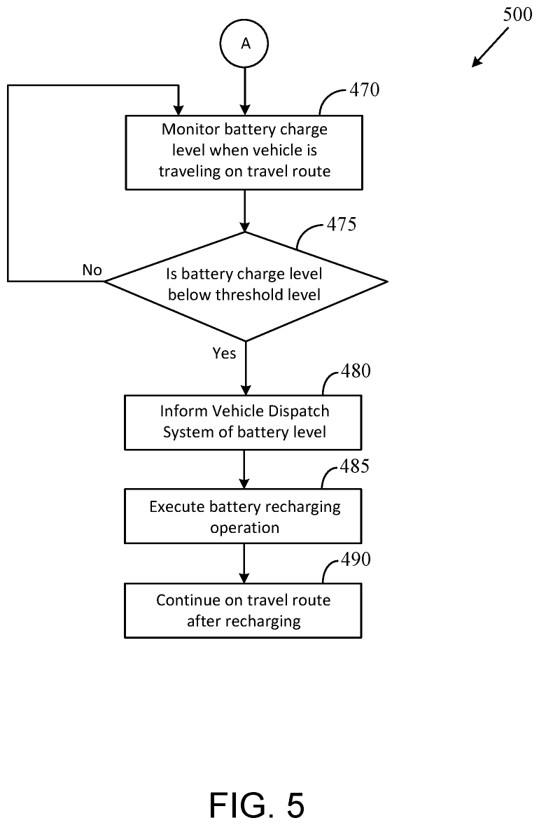

FIG. 5 illustrates a flowchart 500 of an example procedure to provide battery charging to an electric vehicle when moving on a travel route, in accordance with an embodiment of the disclosure. The flowchart 500 can be a continuation of the flowchart 400 after the electric vehicle has been assigned a travel route. At block 470, a battery charge level of a battery in the electric vehicle is monitored while the electric vehicle is traveling on the travel route. The monitoring may be carried out by a vehicle computer of the electric vehicle.

At block 475, a determination is made whether the battery charge level is below a threshold level. The threshold level may be any of various levels set in the vehicle computer by any of various entities, such as, for example, an operations manager of a fleet of vehicles or an owner of the electric vehicle. In an example scenario, the threshold level may be set to a value that permits the electric vehicle to travel a certain distance on the remainder of the charge. The distance may be selected on the basis of a travel range to reach a charging station for recharging the depleted battery or to reach a rendezvous spot where a refueling operation (for a CNG vehicle, for example) can be carried out by a refueling vehicle.

In another example implementation, the operations performed at block 470 and block 475 may be omitted, and a recharging operation of the battery may be scheduled ahead of time before the electric vehicle sets out on the travel route. The predetermined spot at which the recharging/refueling is to be carried out may be determined based on various procedures, such as, for example, calculations based on the battery health of the battery in the electric vehicle, historical data derived from other electric vehicles traversing the travel route, availability of one or more battery charging stations on the travel route, travel time considerations, travel cost considerations, and/or weather conditions on the travel route.

At block 480, a vehicle dispatch system may inform the vehicle computer in the electric vehicle of the depleted battery charge in the battery and/or transmit a command to perform a battery recharging operation. The vehicle computer may issue a driver alert regarding the low battery charge condition when the electric vehicle is a driver-operated vehicle. The vehicle computer may also advise the driver to travel to a recharging station and may provide directions to reach the charging station.

In the case of an autonomous electric vehicle, a computer in the vehicle dispatch system may transmit a command to the vehicle computer to modify a driving characteristic of the vehicle. The vehicle computer may respond to the command received from the vehicle dispatch system by executing various operations such as, for example, automatically engaging a power saving mode, unlocking a reserve battery energy, and/or establishing communications with the recharging station or refueling vehicle. Engaging the power saving mode by the vehicle computer may include actions such as, for example, slowing down a speed of the electric vehicle, reducing an acceleration rate of the electric vehicle, and/or unlocking reserve battery energy for operating the electric vehicle (from a backup battery, for example).

At block 485, the recharging operation may be carried out. In an example implementation, the vehicle computer may communicate with the vehicle dispatch system to inform the vehicle dispatch system of a status of the recharging/refueling operation. Providing continuous updates of a recharging/refueling operation may allow the vehicle dispatch system to perform activities such as pre-arranging a time slot for the electric vehicle at a charging station and/or coordinating a rendezvous operation with a refueling vehicle. Such activities may be particularly helpful in situations such as where a fast charger in the electric vehicle and/or at the charging station is defective or turns out to be inadequate. Timing delays associated with slowdowns in battery charging operations adds to travel costs. The vehicle dispatch system may evaluate the impact of such travel costs on package deliveries and/or on customer service. Unusual events such as a breakdown of the fast charger in the electric vehicle may be stored as historical data pertaining to the electric vehicle and may be subsequently analyzed in order to execute pre-emptive measures in the future.

At block 490, the electric vehicle resumes traveling on the travel route.

FIG. 6 illustrates a flowchart 600 of an example procedure to assign an electric vehicle to a travel route in accordance with an embodiment of the disclosure. At block 605, a query may be originated for obtaining data about a vehicle. In an example scenario, the query may be originated by the computer 106 in order to obtain data about the first electric vehicle 120 from sources such as, for example, the vehicle computer 121. A few examples of such data can include a battery charge status (half full, 90% full, etc.) of a battery of the first electric vehicle 120, an actual battery capacity of a battery of the first electric vehicle 120, and/or a tire pressure of one or more tires of the first electric vehicle 120. The computer 106 may also obtain data pertaining to the first electric vehicle 120 from other sources such as, for example, the vehicle battery database 110 and the vehicle maintenance records system 115. Such data can include, for example, historical information of the first electric vehicle 120 (repairs, breakdown, maintenance, etc.).

At block 610, which may happen in serial or parallel fashion relative to step 605, a query may be originated for obtaining data about one or more travel routes. In an example scenario, the query may be originated by the computer 106 in order to obtain data such as, for example, a distance of a first travel route, a distance of a second travel route, an average speed profile, grade characteristics of the first and/or second travel route, weather conditions along the first and/or second travel route, road rules (speed limits, tolls, etc.), and road regulations. In some cases, data may be obtained by use of a real-time traffic application programming interface (API) and/or a weather API. In some other cases, data may be obtained from other vehicle computers.

At block 615, which may happen in serial or parallel fashion relative to step 605 and/or step 610, a query may be originated for obtaining historical driver behavior data. Block 615 is optional and may be omitted in some implementations. In an example scenario, the query may be originated by the computer 106 in order to obtain data such as a driving record of a driver, a driving characteristic of a driver (safe, aggressive, careless. etc.), an availability of the driver to operate on a travel route, a reliability of the driver, and a work ethic of the driver.

At block 620, an estimated energy consumption by a vehicle for completing a travel route is determined. Some examples of estimated energy consumption (kWh) by an electric vehicle (such as the first electric vehicle 120) are provided in table 300 that is shown in FIG. 3. The estimated energy consumption in the case of other vehicles such as, for example, a gasoline vehicle, a CNG vehicle, or a hybrid electric vehicle may be determined if these other vehicles are being evaluated for a travel route. In some scenarios, the estimated energy consumption of two different vehicles being considered for deployment on two different travel routes may be determined. The two different vehicles can include an alternative energy vehicle and a gasoline vehicle (or hybrid electric vehicle) and the two different travel routes can include a first travel route that is shorter than a second travel route.

At block 625 a probability that a vehicle will need an energy replenishment operation en route on one or more travel routes is determined. In some cases, a threshold probability requirement may be established based on various factors such as, for example, a time for completing a travel route and cost factors.

At block 630, a deployment cost for deploying one or more vehicles is determined. Deployment costs may be broadly characterized under three categories—fuel costs, maintenance costs, and “other operations” costs (as described above).

At block 635, one or more vehicles may be assigned to one or more travel routes based on the deployment costs. In an example scenario, the first electric vehicle 120 may be assigned to the second travel route (the longer route) because a deployment cost for deploying the first electric vehicle 120 on the second travel route is less than a deployment cost for deploying a gasoline vehicle (or hybrid electric vehicle) on the second travel route.

The blocks shown inside a dashed box 660 are optional blocks that may be executed when a vehicle is traveling on an assigned travel route. At block 640, a determination is made whether a threshold probability requirement (established at block 625) has been exceeded. The threshold probability requirement may be exceeded, for example, if an unplanned energy replenishment operation were to occur.

At block 645, a cost of intervention as a result of the threshold probability requirement being exceeded is determined. The costs can include, for example, costs associated with a battery recharging operation or a CNG refilling operation.

At block 650, a cause for an error in establishing an appropriate threshold probability requirement (at block 625) may be identified. This action may be directed, for example, at improving an algorithm that is used for establishing the appropriate threshold probability requirement.

The various procedures and techniques described above may be used not only for implementing short term operational strategies associated with assigning various types of vehicles to various travel routes in a cost-effective manner but may also be used to support long-term fleet strategies such as vehicle purchases, vehicle deployment strategies, and stress-testing. Stress-testing may be used to ensure operational stability in present-day travel route assignment procedures as well as to predict future vehicle deployment strategies. In one example case, Monte Carlo simulation and other mathematical procedures may be used to carry out a stress test for actions such as evaluating a vehicle composition of a vehicle fleet, developing vehicle replacement plans, analyzing vehicle drive cycle characteristics, and/or risk assessment due to disruption of activities due to battery performance. The stress tests may also be leveraged to determine a “degradation-optimal” strategy where actual travel range is safeguarded by restricting battery usage based on battery degradation models combined with applying algorithms such as, for example, a long-short term memory (LSTM) algorithm, to historical telematics data.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize one or more devices that include hardware, such as, for example, one or more processors and system memory, as discussed herein. An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of non-transitory computer-readable media.

Computer-executable instructions comprise, for example, instructions and data which, when executed at a processor, cause the processor to perform a certain function or group of functions. The computer-executable instructions may be, for example, binaries, intermediate format instructions, such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

A memory device, such as the memory 109 provided in the computer 106 of the vehicle dispatch system 105 or in a vehicle computer, can include any one memory element or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, the memory device may incorporate electronic, magnetic, optical, and/or other types of storage media. In the context of this document, a “non-transitory computer-readable medium” can be, for example but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random-access memory (RAM) (electronic), a read-only memory (ROM) (electronic), an erasable programmable read-only memory (EPROM, EEPROM, or Flash memory) (electronic), and a portable compact disc read-only memory (CD ROM) (optical). Note that the computer-readable medium could even be paper or another suitable medium upon which the program is printed, since the program can be electronically captured, for instance, via optical scanning of the paper or other medium, then compiled, interpreted or otherwise processed in a suitable manner if necessary, and then stored in a computer memory.

Those skilled in the art will appreciate that the present disclosure may be practiced in network computing environments with many types of computer system configurations, including in-dash vehicle computers, personal computers, desktop computers, laptop computers, message processors, personal communication devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name, but not function.

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described example embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method comprising:
evaluating a first vehicle for deploying on a first travel route, the evaluating comprising:
determining a first probability that the first vehicle will need a first energy replenishment operation during deployment on the first travel route; and
determining a first deployment cost for the first vehicle, the first deployment cost including a first energy replenishment cost that is based on the first probability;
evaluating a second vehicle for deploying on a second travel route, the evaluating comprises:
determining a second deployment cost for the second vehicle, the second deployment cost including a second energy replenishment cost;
determining that the first deployment cost is less than the second deployment cost; and
assigning the first vehicle to the first travel route and the second vehicle to the second travel route.

2. The method of claim 1, wherein determining the first probability is based on an unplanned energy replenishment operation and/or on satisfying a threshold probability requirement.

3. The method of claim 1, wherein the first vehicle is a first battery-operated vehicle and wherein the first deployment cost is further based on a battery health of a battery that provides power to operate the first battery-operated vehicle, the battery health defined by a diminished charge retaining capacity of the battery, a diminished watt-hour rating of the battery, a diminished charging rate of the battery, and/or a diminished mean-time-between-failures (MTBF) rating of the battery in comparison to an original charge retaining capacity of the battery, an original watt-hour rating of the battery, an original charging rate of the battery, and/or an original mean-time-between-failures (MTBF) rating of the battery respectively.

4. The method of claim 3, wherein the first energy replenishment operation is a battery recharging operation, and wherein the first probability is based on a weather condition on the first travel route, a driving record of a driver of the first battery-operated vehicle, a terrain characteristic of the first travel route, a towing cost for the first battery-operated vehicle, and/or a time spent to execute the first energy replenishment operation.

5. The method of claim 3, wherein the second vehicle is one of a gasoline-operated vehicle or a hybrid vehicle, and the method further comprises:
evaluating a second battery-operated vehicle for deploying on a third travel route, the evaluating comprising:
determining a second probability that the second battery-operated vehicle will need a second energy replenishment operation during deployment on the third travel route; and
determining a third deployment cost, the third deployment cost including a third energy replenishment cost that is based on the second probability;
determining that the third deployment cost is more than the second deployment cost; and
re-assigning the one of the gasoline-operated vehicle or the hybrid vehicle to the third travel route.

6. The method of claim 5, wherein evaluating the second battery-operated vehicle for deploying on the third travel route further comprises:
determining that the second battery-operated vehicle has sufficient range for deployment on the third travel route without the second energy replenishment operation.

7. The method of claim 1, wherein the first deployment cost is further determined on a charging fee paid to a provider of an unexpected energy replenishment operation, a first cost penalty associated with a time delay for execution of the unexpected energy replenishment operation, and/or a second cost penalty associated with a deviation from the first travel route to execute the unexpected energy replenishment operation.

8. A method comprising:
evaluating a battery health of a rechargeable battery that is installed in an electric vehicle;
assigning the electric vehicle to a travel route;
identifying a first location on the travel route where a charge level in the rechargeable battery is expected to drop below a threshold level; and
arranging for a recharging operation of the rechargeable battery based on identifying the first location.

9. The method of claim 8, wherein arranging for the recharging operation comprises:
transmitting a request to a charging station on the travel route, prior to the electric vehicle reaching the first location on the travel route.

10. The method of claim 8, wherein arranging for the recharging operation comprises:
arranging for a second vehicle to meet the electric vehicle at the first location and transfer power from a first battery of the second vehicle to the rechargeable battery of the electric vehicle.

11. The method of claim 8, wherein arranging for the recharging operation comprises:
dispatching a replacement vehicle and/or a service vehicle to a second location along the travel route prior to the electric vehicle reaching the second location.

12. The method of claim 8, wherein evaluating the battery health of the rechargeable battery comprises determining a charge retaining capacity, a watt-hour rating, and/or a mean-time-between-failures (MTBF) rating of the rechargeable battery.

13. The method of claim 9, wherein evaluating the battery health of the rechargeable battery comprises monitoring an electric charge consumption by the electric vehicle traveling on the travel route.

14. The method of claim 8, further comprising:
determining a discharge rate of the rechargeable battery by the electric vehicle traveling on the travel route; and
transmitting a command from a base station to the electric vehicle to modify a driving characteristic of the electric vehicle based on the discharge rate.

15. A system comprising:
a memory that stores computer-executable instructions; and
a processor configured to access the memory and execute the computer-executable instructions to perform operations comprising:
evaluating a first vehicle for deploying on a first travel route, the evaluating comprising:
determining a first probability that the first vehicle will need a first energy replenishment operation during deployment on the first travel route; and
determining a first deployment cost for the first vehicle, the first deployment cost including a first energy replenishment cost that is based on the first probability;
evaluating a second vehicle for deploying on a second travel route, the evaluating comprises:
determining a second deployment cost for the second vehicle, the second deployment cost including a second energy replenishment cost;
determining that the first deployment cost is less than the second deployment cost; and
assigning the first vehicle to the first travel route and the second vehicle to the second travel route.

16. The system of claim 15, wherein the first vehicle is a first battery-operated vehicle and wherein the first deployment cost is further based on a battery health of a battery that provides power to operate the first battery-operated vehicle, the battery health defined by a diminished charge retaining capacity of the battery, a diminished watt-hour rating of the battery, a diminished charging rate of the battery, and/or a diminished mean-time-between-failures (MTBF) rating of the battery in comparison to an original charge retaining capacity of the battery, an original watt-hour rating of the battery, an original charging rate of the battery, and/or an original mean-time-between-failures (MTBF) rating of the battery respectively.

17. The system of claim 16, wherein the first energy replenishment operation is a battery recharging operation, and wherein the first probability is based on a weather condition on the second travel route, a driving record of a driver of the first battery-operated vehicle, a terrain characteristic of the second travel route, a towing cost for the first battery-operated vehicle, and/or a time spent to execute the first energy replenishment operation.

18. The system of claim 17, wherein the second vehicle is one of a gasoline-operated vehicle or a hybrid vehicle, and wherein the processor is further configured to access the memory and execute additional computer-executable instructions to perform operations comprising:
evaluating a second battery-operated vehicle for deploying on a third travel route, the evaluating comprising:
determining a second probability that the second battery-operated vehicle will need a second energy replenishment operation during deployment on the third travel route; and
determining a third deployment cost, the third deployment cost including a third energy replenishment cost that is based on the second probability;
determining that the third deployment cost is more than the second deployment cost; and
re-assigning the one of the gasoline-operated vehicle or the hybrid vehicle to the third travel route.

19. The system of claim 18, wherein evaluating the second battery-operated vehicle for deploying on the third travel route further comprises:
determining that the second battery-operated vehicle has sufficient range for deployment on the third travel route without the second energy replenishment operation.

20. The system of claim 15, wherein the first deployment cost is further determined on a charging fee paid to a provider of an unexpected energy replenishment operation, a first cost penalty associated with a time delay for execution of the unexpected energy replenishment operation, and/or a second cost penalty associated with a deviation from the first travel route to execute the unexpected energy replenishment operation.
